(19) United States
(12) Patent Application Publication
(10) Pub. No.: US 2018/0252970 A1
(43) Pub. Date: Sep. 6, 2018

(54) DISPLAY DEVICE

(71) Applicant: Japan Display Inc., Minato-ku (JP)

(72) Inventors: Yasushi IWAKABE, Tokyo (JP); Jin HIROSAWA, Tokyo (JP); Koichi IGETA, Tokyo (JP)

(73) Assignee: Japan Display Inc., Minato-ku (JP)

(21) Appl. No.: 15/877,699

(22) Filed: Jan. 23, 2018

(30) Foreign Application Priority Data
Mar. 3, 2017 (JP) 2017-040041

(51) Int. Cl. G02F 1/1343; G09G 3/36; G09G 3/20; G02F 1/1335; G02F 1/1333

(52) U.S. Cl. CPC G02F 1/134309; G09G 3/3674; G09G 3/2003; G02F 2001/134345; G02F 1/133345; G02F 2201/123; G02F 2201/121; G02F 1/133512

(57) ABSTRACT

A display device includes: a light shielding film; a plurality of image lines and a plurality of scanning lines present on an insulating base material; a pixel electrode and a common electrode present in a sub-pixel area surrounded by the plural image lines and the plural scanning lines in a plan view; and a liquid crystal layer driven by an electric field generated between the pixel electrode and the common electrode. A shape of the pixel electrode in a light transmission area surrounded by the light shielding film is a linear shape having no bending portion. The common electrode is overlapped on the plural image lines and the plural scanning lines, and has an opening overlapped on the pixel electrode. Further, each liquid crystal molecule of the liquid crystal layer has a positive dielectric constant. The sub-pixel area has a width of 13 μm or less.

### CROSS-REFERENCE TO RELATED APPLICATION

The present application claims priority from Japanese Patent Application No. 2017-40041 filed on Mar. 3, 2017, the content of which is hereby incorporated by reference into this application.

### TECHNICAL FIELD OF THE INVENTION

The present invention relates to a display device, for example, an effective technique applicable to a liquid crystal display device.

### BACKGROUND OF THE INVENTION

A display device such as a liquid crystal display device includes: a pixel electrode(s) and a common electrode(s) present in a sub-pixel area surrounded by a plurality of image lines and a plurality of scanning lines on an insulating base material; and a liquid crystal layer(s) driven by an electric field generated between the pixel electrode and the common electrode. Incidentally, Japanese Patent Application Laid-open Nos. 2015-40881, H9-179096, and 2015-118193 (Patent Documents 1-3) are given as examples of conventional techniques.

### SUMMARY OF THE INVENTION

The display device as described above is used in, for example, a head mounted display for virtual reality (VR). In this head mounted display, achievement of higher definition is required for looking at a display screen a distance of a few centimeters away therefrom. Additionally, in the display for VR, high-speed response is required for adaption to a moving image(s). Therefore, arrangement and formation of the good common electrode for one pixel electrode are also required.

Thus, the present invention has an object of providing a display device that is adaptable to the requirements as mentioned above and realizes the high-speed response and the achievement of higher definition.

The following is a brief description of an outline of the typical invention disclosed in the present application.

A display device according to an embodiment includes: an insulating base material; a plurality of image lines and a plurality of scanning lines over the insulating base material; a light shielding film overlapped on the image lines and the scanning lines; a first electrode and a second electrode present in at least one sub-pixel area surrounded by the image lines and the scanning lines in a plan view; and a liquid crystal layer driven by an electric field generated between the first and second electrodes. A shape of the first electrode in a light transmission area surrounded by the light shielding film is a linear shape having no bending portion. The second electrode is overlapped on the image lines and the scanning lines, and has an opening overlapped on the first electrode. Further, each liquid crystal molecule in the liquid crystal layer has a positive dielectric constant. Additionally, the sub-pixel area has a width of 13 μm or less.

### BRIEF DESCRIPTIONS OF THE DRAWINGS

FIG. 1 is a plan view showing an example of a display device according to an embodiment;

FIG. 2 is a sectional view taken along line A-A of FIG. 1;

FIG. 3 is a drawing showing an example of an equivalent circuit of the display device according to the embodiment;

FIG. 4 is an explanatory diagram showing an example of a head mounted display to which the display device according to the embodiment is applied;

FIG. 5 is a plan view showing an example of a sub-pixel structure of the display device according to the embodiment;

FIG. 6 is a sectional view taken along line B-B of FIG. 5;

FIG. 7 is an explanatory diagram showing an example of a relationship between the highest transmissivity and an applied voltage with respect to definition of each mode about an embodiment and a comparative example to the embodiment;

FIG. 8 is an explanatory diagram showing an example of a relationship between a transmissivity and an applied voltage with respect to definition of each mode about an embodiment and a comparative example to the embodiment;

FIG. 9A is a plan view showing a modification of a sub-pixel structure of the display device according to the embodiment;

FIG. 9B is a plan view showing another modification of the sub-pixel structure of the display device according to the embodiment;

FIG. 10 is a plan view showing an example of a sub-pixel structure of a display device according to another embodiment;

FIG. 11 is a sectional view taken along line C-C of FIG. 10; and

FIG. 12 is a plan view showing yet another modification of the sub-pixel structure of the display device according to the embodiment.

### DESCRIPTIONS OF THE PREFERRED EMBODIMENTS

Hereinafter, embodiments of the present invention will be described in detail with reference to the accompanying drawings.

Note that the disclosure is mere an example, and it is a matter of course that any alteration that is easily made by a person skilled in the art while keeping a gist of the present invention is included in the present invention. In addition, the drawings schematically illustrate a width, a thickness, a shape and the like of each portion as compared to actual aspects in order to make the description clearer, but the drawings are mere examples and do not limit the interpretation of the present invention.

In addition, the same reference characters are applied to the same elements as those described in relation to the foregoing drawings in the present specification and the respective drawings, and detailed descriptions thereof will be appropriately omitted in some cases.

Also, in some drawings used in the following embodiment, hatching is omitted even in a cross-sectional view so as to make the drawings easy to see. In addition, hatching is used even in a plan view so as to make the drawings easy to see.

Similarly, in the description of the embodiments, the phrases “α includes A, B, or C”, “α includes any of A, B, and C”, and “α includes one selected from a group composed of A, B, and C” exclude, unless otherwise specified, a case where α includes a plurality of combinations of A to C”. Further, those phrases do not exclude a case where α includes another element or other elements”.

Techniques as explained in embodiments mentioned below are widely applicable to a display device having a structure for supplying a signal(s) from a circumference of the display device to a plurality of elements provided in a display area in which an electrooptical layer(s) is provided. In the following embodiments, a liquid crystal display device will be dealt with and described as a typical example of the display device.

### Embodiment

<Configuration of Display Device>

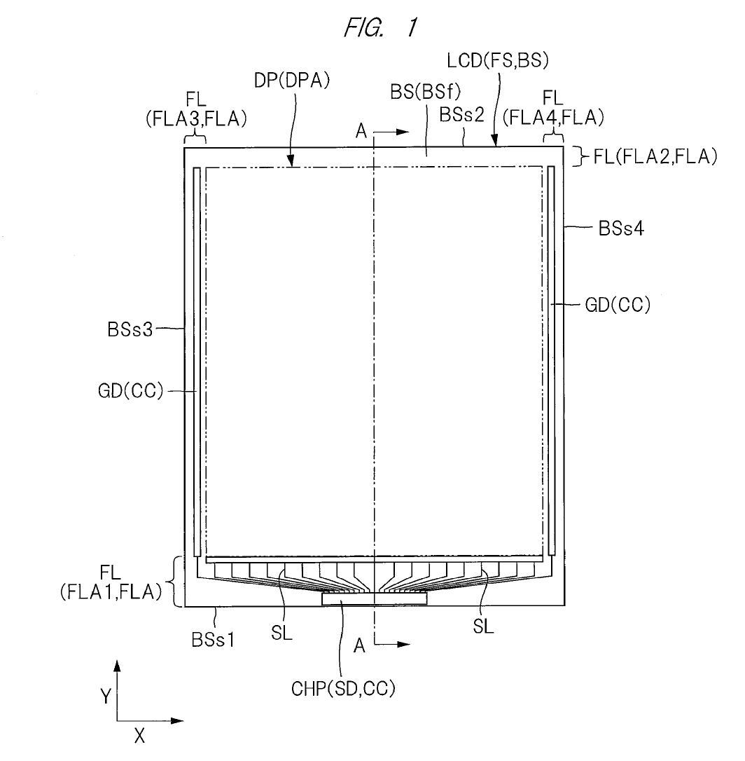

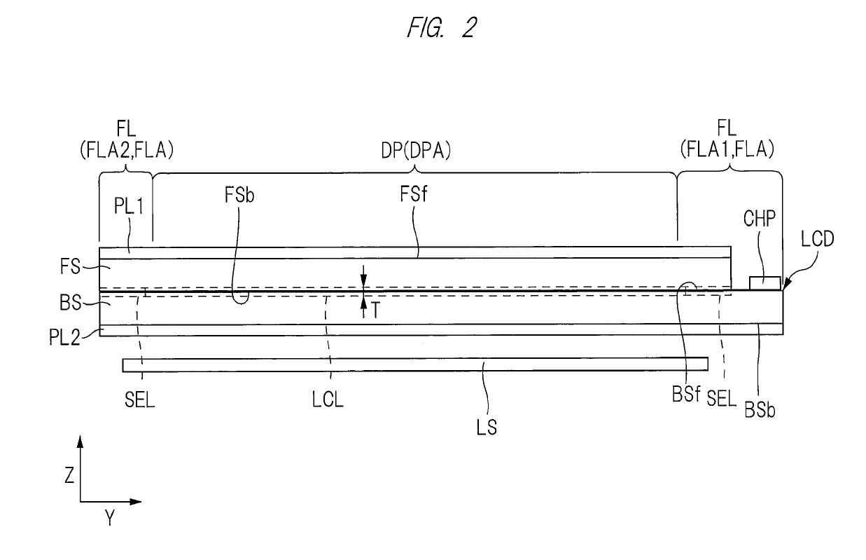

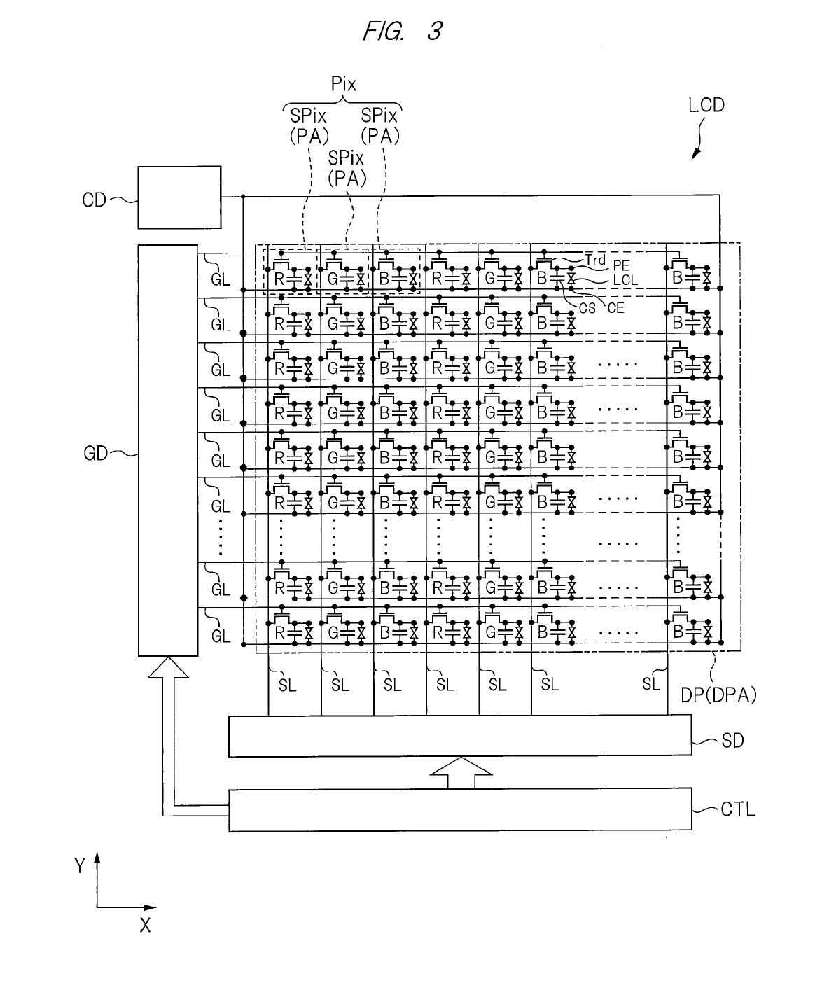

A configuration of a display device will be firstly described with reference to FIGS. 1 and 2. FIG. 1 is a plan view showing an example of a display device according to an embodiment. FIG. 2 is a sectional view taken along A-A of FIG. 1. Incidentally, illustrations of a scanning line(s) GL (see FIG. 3 described later) and an image line(s) SL (see FIG. 3 describe later) in a display area PA will be omitted in FIG. 1 in order to make it easier to see the above configuration. Additionally, FIG. 2 is a sectional view, but hatchings in FIG. 2 will be omitted in order to make it easier to see the above configuration.

As shown in FIG. 1, a display device LCD according to an embodiment has a display unit DP for displaying an image(s). The display device LCD includes an array substrate BS and an opposite substrate FS. For example, however, an area, in which the display unit DP is provided out of the entirety of the array substrate BS, is a display area DPA. The display device LCD also has, in a plan view, a no-image displaying frame section (periphery section) FL that is a circumferential portion of the display unit DP. An area in which the frame section FL is provided is a frame area FLA. That is, the frame area FLA is an outer area (periphery area) of the display area DPA.

Incidentally, in the present specification, the term “in a plan view” means, as shown in FIG. 1, a case of being viewed from a direction perpendicular to an opposite surface BSf (see FIG. 2) as a main surface of the array substrate BS. Additionally, two directions intersecting each other, preferably orthogonal to each other in the opposite surface BSf as the main surface of the array substrate BS are set as X-axis and Y-axis directions, and a direction perpendicular to the opposite substrate BSf as the main surface of the array substrate BS is set as a Z-axis direction (see FIG. 2).

The display device LCD also has a structure in which a liquid crystal layer serving as an electrooptical layer is formed between a pair of substrates oppositely arranged. That is, as shown in FIG. 2, the display device LCD includes: the opposite substrate FS on a display screen side; the array substrate BS located opposite the opposite substrate FS; and a liquid crystal layer LCL arranged between the opposite substrate FS and the array substrate BS.

Additionally, in a plan view, the array substrate BS shown in FIG. 1 has: a side BSs1 extending along the X-axis direction; a side BSs2 extending parallel to the side BSs1 and along the X-axis direction; a side BSs3 extending along the Y-axis direction intersecting the X-axis direction, preferably orthogonal to the X-axis direction; and a side BSs4 extending parallel to the side BSs3 and along the Y-axis direction. Respective distances from the sides BSs2, BSs3, and BSs4, which the array substrate BS shown in FIG. 1 has, to the display unit DP are almost the same, and are shorter than a distance from the side BSs1 to the display unit DP.

The display unit DP has a pixel(s) (see FIG. 3 described later) serving as a plurality of display elements. That is, a plurality of pixels Pix are provided on the display area DPA of the array substrate BS. The plurality of pixels Pix are arranged in a matrix in the X-axis and Y-axis directions. Each of the plurality of pixels Pix in the present embodiment has a thin-film transistor TFT formed on an opposite substrate BSf side of the array substrate BS in the display area DPA.

As explained with reference to FIG. 3 described later, the display device LCD has a plurality of scanning lines GL and a plurality of image lines SL. As explained with reference to FIG. 3 described later, each of the scanning lines GL is electrically connected to the pixels Pix arranged in the X-axis direction, and each of the image lines SL is electrically connected to the pixels Pix arranged in the Y-axis direction.

The display device LCD also has a drive circuit CC. The drive circuit CC includes a scanning-line drive circuit GD and an image-line drive circuit SD. As explained with reference to FIG. 3 described later, the scanning-line drive circuit GD is electrically connected to the pixels Pix via the scanning lines GL, and the image-line drive circuit SD is electrically connected to the pixels Pix via the image lines SL.

In an example shown by FIG. 1, the frame area FLA includes frame areas FLA1, FLA2, FLA3, and FLA4. The frame area FLA1 is, in a plan view, an area that is disposed on one side (downside in FIG. 1) of the Y-axis direction with respect to the display area DPA and on which a semiconductor chip CHP and/or a not-shown exterior circuit substrate are mounted. The frame area FLA2 is an area disposed on an opposite side (upside in FIG. 1) of the frame area FLA1 and sandwiching the display area DPA with the frame area FLA1. In a plan view, the frame area FLA3 is an area disposed on one side (left in FIG. 1) of the X-axis direction with respect to the display area DPA, and the frame area FLA4 is an area disposed on an opposite side of the frame area FLA3 and sandwiching the display area DPA with the frame area FLA3.

In the example shown by FIG. 1, a semiconductor chip(s) CHP is provided on the array substrate BS. The semiconductor chip CHP is mounted in the frame area FLA1 in a plan view. The image-line drive circuit SD is provided in the semiconductor chip CHP. Therefore, the image-line drive circuit SD is an area located on the opposite surface BSf side of the array substrate BS, and is provided in the frame area FLA1 that is an area disposed on one side of the Y-axis direction with respect to the display area DPA.

Incidentally, in some cases, the frame area FLA1 on which the semiconductor chip CHP is mounted is referred to as a “lower frame area”, and the frame area FLA2 sandwiching the display area DPA and disposed opposite the frame area FLA1 is referred to as an “upper frame area”. At this time, the frame areas FLA3 and FLA4 disposed on both sides of a direction (X-axis direction) intersecting a direction (Y-axis direction) of disposing the frame area FLA1 with respect to the display area DPA are, in some cases, referred to as a “left frame area” and a “right frame area”, respectively.

Additionally, the semiconductor chip CHP may be provided in the frame area FLA1 by using a so-called chip on glass (COG) technique, or may be provided outside the array substrate BS and connected to the array substrate BS via flexible printed circuits (FPC). The frame area FLA1 is provided with a terminal section(s) for connecting the array substrate BS and an outside.

As shown in FIG. 2, the display device LCD also has a seal SEL disposed in the frame area FLA. The seal SEL is formed so as to continuously surround a circumference of the display unit DP, and the opposite substrate FS and the array substrate BS shown in FIG. 2 adhere and are fixed to each other by a sealing material provided on the seal SEL. Thus, since the seal SEL is provided to the circumference of the display unit DP, the liquid crystal layer LCL as an electrooptical layer can be sealed.

As shown in FIG. 2, also provided on a back surface BSb side of the array substrate BS in the display device LCD are: a backlight LS composed of an optical element such as a light source and a diffuser panel; and a polarizer PL2 for polarizing light generated from the backlight LS. The polarizer PL2 is fixed to the array substrate BS. Meanwhile, a polarizer PL1 is provided on a back surface FSf side of the opposite substrate FS. The polarizer PL1 is fixed to the opposite substrate FS.

Incidentally, FIG. 2 illustrates, as an example, basic configurative components of the display device LCD, but other components such as a touch panel and a protective layer can be added, as a modification, to the configurative components shown in FIG. 2.

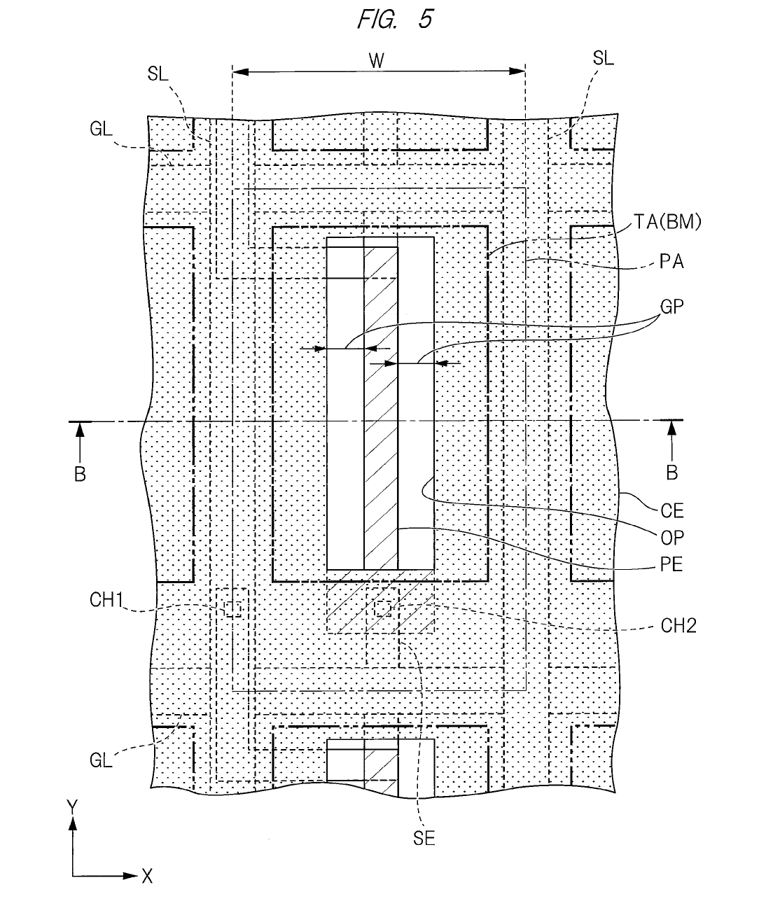

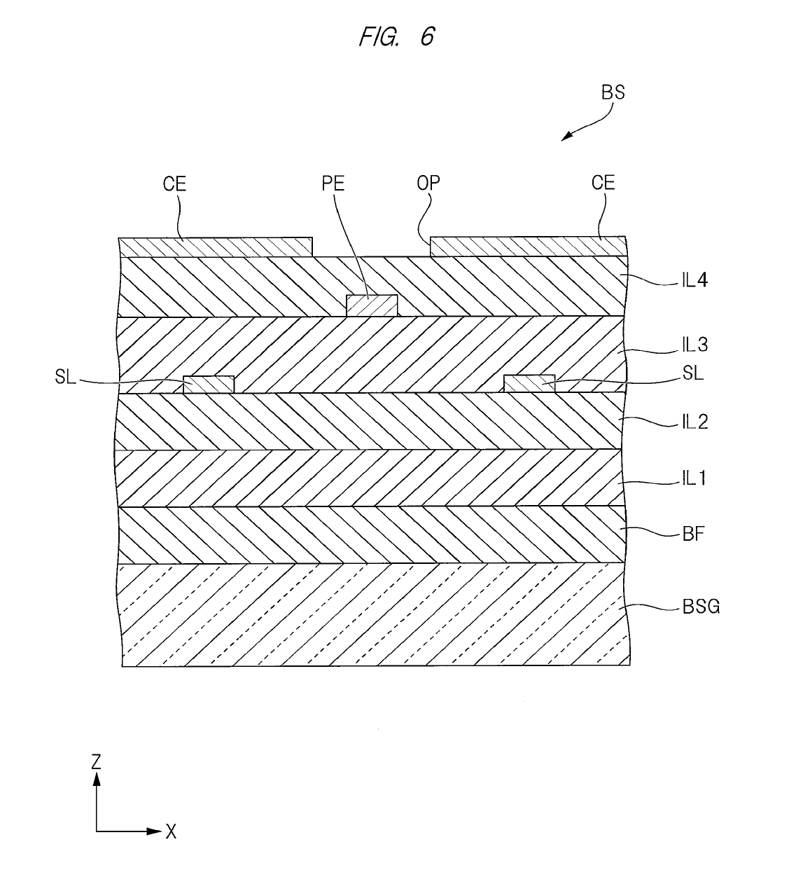

As explained by FIGS. 5 and 6 etc. describe later, the display device LCD also has a plurality of pixel electrodes PE and a plurality of common electrodes CE. The display device LCD in the present embodiment is a display device having a transverse electric-field mode which is a method of applying an electric field to the liquid crystal layer LCL, so that the pixel electrodes PE and the common electrodes CE are each formed on the array substrate BS.

The array substrate BS is composed of a glass substrate etc., and an image-displaying circuit(s) is mainly formed thereon. The array substrate BS has an opposite surface BSf (see FIG. 2) located on an opposite substrate FS side, and a back surface BSb (see FIG. 2) located opposite the opposite surface. A drive element such as a TFT, and a plurality of pixel electrodes PE are formed in a matrix on the opposite surface BSf side of the array substrate BS. Additionally, the array substrate BS includes a display area DPA, and a frame area FLA provided outside the display area DPA. The array substrate BS may be formed of a resin made of polyimide etc. other than a glass substrate.

Meanwhile, the opposite substrate FS is composed of a glass substrate etc., and a color filter (not shown) for forming a color-displayed image(s) is formed thereon. The opposite substrate FS has a back surface FSf (see FIG. 2) that is a display screen side, and an opposite surface FSb (see FIG. 2) located opposite the back surface FSf. The opposite substrate FS is arranged opposite the array substrate BS in a state where the opposite surface BSf of the array substrate BS and the opposite surface FSb of the opposite substrate FS opposes each other. Incidentally, the array substrate BS may be also referred to as a “TFT substrate”, and the opposite substrate FS on which the color filter is formed may be also referred to as a “color filter substrate”.

The color filter of the opposite substrate FS has such a configuration that color filter pixels with three colors composed of red, green, and blue are periodically arranged. A light shielding film (not shown) is formed on a boundary between the respective color filter pixels.

In the display device LCD in the present embodiment, light emitted from the backlight LS (see FIG. 2) is filtered by the light shielding plate PL2 (see FIG. 2) and is incident on the liquid crystal layer LCL. The light incident on the liquid crystal layer LCL is caused to change its polarization state by liquid crystal, and is emitted from the opposite substrate FS. At this time, by an electric field generated by applying a voltage to the pixel electrodes PE and the common electrodes CE, an orientation(s) of the liquid crystal is controlled, and the liquid crystal layer LCL functions as an optical shutter.

<Equivalent Circuit of Display Device>

Next, an equivalent circuit of the display device LCD will be explained with reference to FIG. 3. FIG. 3 is a view showing an example of an equivalent circuit of the display device LCD according to the embodiment.

As shown in FIG. 3, the display unit DP in the display device LCD has a plurality of pixels Pix. The plurality of pixels Pix are, in a plan view, provided on the array substrate BS in the display area DPA, and arranged in a matrix in the X-axis and Y-axis directions.

The display device LCD also has a plurality of scanning lines GL and a plurality of image lines SL. The scanning lines GL are provided on the array substrate BS (e.g., see FIG. 2) in the display area DPA, and each extend in the X-axis direction and are arranged in the Y-axis direction. The image lines SL are provided on the array substrate BS in the display area DPA, and each extend in the Y-axis and are arranged in the X-axis direction. The image lines SL and the scanning lines GL intersect each other.

Each of the pixels Pix includes a sub-pixel SPix, the sub-pixel indicating each color of red (R), green (G), and blue (B). Each of the sub-pixels SPix is provided in a sub-pixel area PA surrounded by the two scanning lines adjacent to each other and the two image lines adjacent to each other, but may have another structure.

Each of the sub-pixels SPix has: a transistor Trd composed of a thin-film transistor(s); a pixel electrode PE connected to a drain electrode of the transistor Trd; and a common electrode CE sandwiching the pixel electrode PE and the liquid crystal layer LCL and opposing to them. Shown in FIG. 3 is a retention capacity CS formed between the common electrode CE and the pixel electrode PE. Incidentally, a drain electrode and a source electrode of the thin-film transistor are appropriately switched by polarities of their potentials.

The drive circuit CC (see FIG. 1) of the display device LCD has an image-line drive circuit SD, a scanning-line drive circuit GD, a control circuit CTL, and a common-electrode drive circuit CD. The image-line drive circuit SD, the control circuit CTL, and the common-electrode drive circuit CD are provided in the semiconductor chip CHP mounted on the frame area FLAT. The scanning-line drive circuit GD is provided in the frame areas LFA3 and FLA4.

A source electrode of each of the transistors Trd in the sub-pixels SPix arranged in the Y-axis direction is connected to the image lines SL. Additionally, each of the image lines SL is connected to the image-line drive circuit SD. The image-line drive circuit SD supplies an image signal(s) to each image line SL.

Additionally, a gate electrode of each of the transistors Trd in the sub-pixels SPix arranged in the X-axis direction is connected to the scanning lines GL. Further, each scanning line GL is connected to the scanning-line drive circuit GD. The scanning-line drive circuit GD supplies a scanning signal(s) to each scanning line GL.

The control circuit CTL controls the image-line drive circuit SD, the scanning-line drive circuit GD, and the common-electrode drive circuit CD based on a display control signal(s) such as display data, a clock signal, and a display timing signal transmitted from outside the display device LCD.

The control circuit CTL: appropriately converts display data or a display control signal(s) supplied from outside based on arrangement of the sub-pixels in the display device LCD, a display method, presence or absence of a RGB switch (omitted in drawing), presence or absence of a touch panel (omitted in drawing), or the like; and outputs the converted data or signal to the image-line drive circuit SD, the scanning-line drive circuit GD, and the common-electrode drive circuit CD.

<Head Mounted Display>

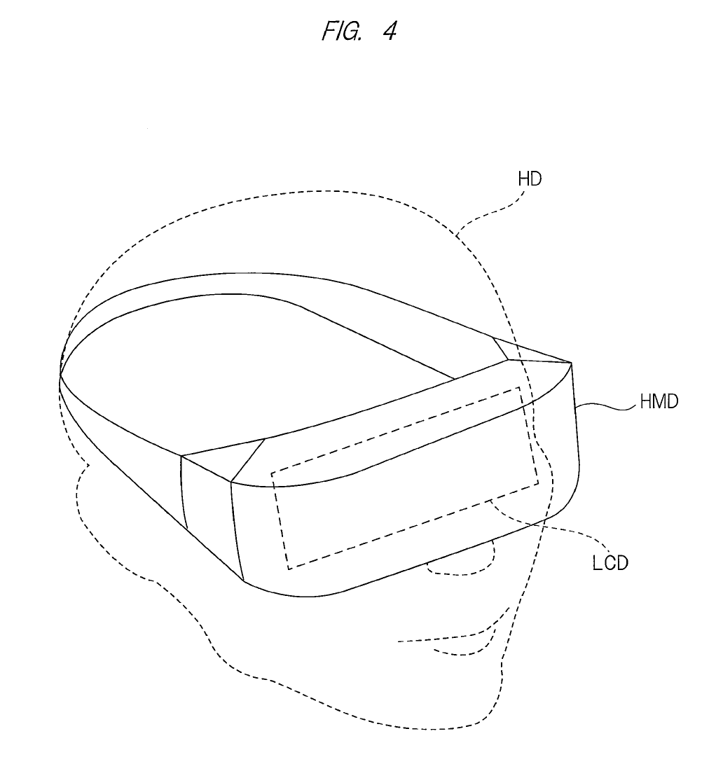

The display device LCD as mentioned above is used in, for example, a head mounted display HMD for virtual reality (VR) as shown in FIG. 4. FIG. 4 is an explanatory diagram showing an example of a head mounted display HMD to which the display device according to the embodiment is applied.

The head mounted display HMD is used by attaching, to a person's head, a main body in which the above-mentioned display device LCD is incorporated. Thus, the person attaching the main body can look at an image(s) projected onto a display screen of the display device LCD. This head mounted display HMD requires achievement of higher definition in order to look at the display screen a distance of a few centimeters away therefrom. Additionally, in the display for VR, high-speed response is required for adaption to a moving image(s).

Thus, the present embodiment has an object of providing a display device that is adaptable to the requirements as mentioned above and realizes the high-speed response and the achievement of higher definition.

In the display device LCD, for example, the number of electrode pieces divided from the pixel electrode PE (comb-tooth shaped electrode) to be physically disposed in one pixel decreases as definition becomes higher. The number of electrode pieces to be divided becomes zero finally, and the pixel electrode is regarded as one bundle-shaped (linear shape) electrode. That is, the sub-pixel structure for realizing achievement of higher definition becomes a structure, in which one pixel electrode PE is disposed at an opening of the common electrode CE, since an area per one pixel is small.

Additionally, the display device LCD has, as a method of applying an electric field to the liquid crystal layer LCL, a vertical electric-field mode and a transverse electric-field mode. In the transverse electric-field mode, a transverse electric field is applied to liquid crystal molecules by mutually insulating a pair of pixel electrode PE and common electrode CE and providing them onto an inner surface side of the array substrate BS, a pair of array substrate BS and opposite substrate FS being arranged so as to sandwich the liquid crystal layer LCL therebetween. This transverse electric-field mode has: an in-plane switching (IPS) mode in which the paired pixel electrode PE and common electrode CE are not overlapped in a plan view; and a fringe field switching (FFS) mode in which the both electrodes are overlapped.

The IPS mode generally has a weak electric field with respect to liquid crystal on the pixel electrode PE and at an end of the electrode. For this reason, the liquid crystal on the pixel electrode PE does not rotate completely, and its transmissivity makes it easy to lower. In contrast to this, the FFS mode generally has a relatively high transmissivity even on the pixel electrode and/or between the pixel electrodes since the pixel electrode PE and the common electrode CE create a strong fringe electric field.

For example, in a display device having a sub-pixel resolution of 500 ppi or less, the IPS mode can obtain almost the same transmissivity as the FFS mode, but needs an application of a much higher voltage than the FFS mode. Meanwhile, if the definition of the sub-pixel is made higher and the number of pixel electrodes PE is regarded as one bundle, the number of electrodes in the device decreases drastically. In this case, depending on a specific condition(s), the transmissivity of the IPS mode becomes almost the same as that of the FFS mode, or the transmissivity of the IPS mode becomes higher than that of the FFS mode. This is for the following reasons. In a case of the FFS mode, since an electrode width per one electrode is narrow, a decrease in the number of electrodes makes it difficult to uniformly apply an electric field to the entirety of the sub-pixel area PA. This may bring a case in which the transmissivity of the IPS mode becomes higher as a whole of the sub-pixel.

Additionally, whether the liquid crystal used in the liquid crystal layer LCL is a positive or negative type affects realization of the high-speed response of the display device LCD. In order to make response speed higher, positive type liquid crystal with lower viscosity is more advantageous than negative type liquid crystal. Incidentally, the positive type liquid crystal has a positive dielectric anisotropy in which a dielectric constant at a time of applying a voltage to liquid crystal molecules in a long-axis direction is larger in magnitude than that in a short-axis direction. Meanwhile, the negative type liquid crystal has a negative dielectric anisotropy in which a dielectric constant at a time of applying a voltage to liquid crystal molecules in a long-axis direction is smaller in magnitude than that in a short-axis direction.

<Sub-Pixel Structure>

Hereinafter, a sub-pixel structure in a display device LCD according to the embodiment will be explained with reference to FIGS. 5 and 6. FIG. 5 is a plan view showing an example of a sub-pixel structure in the display device according to the embodiment. FIG. 6 is a sectional view taken along line B-B of FIG. 5. FIGS. 5 and 6 show a sub-pixel structure of one pixel among the plurality of sub-pixels SPix arranged in a matrix in the X-axis and Y-axis directions. Each of the sub-pixels SPix is provided in a sub-pixel area PA surrounded by two adjacent scanning lines GL and two adjacent image lines SL. Further, each of the sub-pixels SPix has a light transmission area TA surrounded by the light shielding film BM.

As shown in FIGS. 5 and 6, the array substrate BS includes: an insulating base material BSG; a plurality of image lines SL and a plurality of scanning lines GL over the insulating base material BSG; and a sub-pixel area PA surrounded by the plural image lines SL and the plural scanning lines GL. The array substrate BS also has a first electrode and a second electrode in the sub-pixel area PA. In the present embodiment, the first electrode is a pixel electrode PE, and the second electrode is a common electrode CE. The array substrate BS on the opposite substrate FS side has a liquid crystal layer LCL driven by an electric field generated between the pixel electrode PE and the common electrode CE.

As shown in FIG. 6, the array substrate BS has, for example, a base film BF and insulating layers IL1 to IL4 on and over the insulating base material BSG. The base film BF is provided on the insulating base material BSG in the array substrate BS. A semiconductor layer SE (see FIG. 5) is provided on or over the base film BF. The semiconductor layer SE is covered with the insulating layer IL1. The scanning lines GL (see FIG. 5) are provided on or over the insulating layer IL1. The scanning lines GL are covered with the insulating layer IL2. The image lines SL are provided on the insulating layer IL2. The image lines SL are covered with the insulating layer IL3. The pixel electrode PE is provided on the insulating layer IL3. The pixel electrode PE is covered with the insulating layer IL4. The common electrode CE is provided on the insulating layer IL4.

As shown in FIG. 5, the plural scanning lines GL in the array substrate BS each extends in the X-axis direction, and are arranged in the Y-axis direction. The plural image lines SL each extend in the Y-axis direction, and are arranged in the X-axis direction. An area surrounded by the two adjacent scanning lines GL and the two adjacent image lines SL is the sub-pixel area PA. The image line SL is connected to the semiconductor layer SE through a contact hole CH1. The image electrode PE has a liner shape extending in the Y-axis direction. The image electrode PE is connected to the semiconductor layer SE through a contact hole CH2. The common electrode CE has an opening OP that is opened so as for gaps to be formed between the common elected CE and the pixel electrode PE and that has a linear shape extending in the Y-axis direction.

The display device LCD in the present embodiment is applied to a display device with a transverse electrode-field mode, so that the pixel electrode PE and the common electrode CE are each formed on the array substrate BS. On the array substrate BS, the common electrode CE is located closer to the liquid crystal layer LCL than the pixel electrode PE. The pixel electrode PE and the common electrode CE are each formed by a transparent conductive material made of, for example, Indium Tin Oxide (ITO) etc.

As shown in FIG. 5, a shape of the pixel electrode PE is a linear shape having no branch part in the light transmission area TA surrounded by the light shielding film BM. In FIG. 5, the light transmission area TA is an area inside a rectangle illustrated by a dash-double-dot line, and the light shielding film BM is a film arranged in an area outside the rectangle illustrated by this dash-double-dot line. The light shielding film BM is overlapped on the plural image lines SL and the plural scanning lines GL. Additionally, the common electrode CE having an opening OP overlapped on the pixel electrode PE. That is, the pixel electrode PE adopts a structure in which a single pixel electrode is arranged in the opening OP of the common electrode CE, i.e., a structure with a so-called one-electrode shape.

Further, regarding the pixel electrode PE and the common electrode CE, there is a gap GP between an end of the pixel electrode and each end of the common electrode CE in a plan view. Moreover, the common electrode CE is formed outside the pixel electrode PE in the sub-pixel area PA in a plan view. In addition thereto, the pixel electrode PE and the common electrode CE are not overlapped in the light transmission area TA. That is, the pixel electrode PE and the common electrode CE each adopt, as a method of applying an electric field to the liquid crystal layer LCL, a structure for realizing the IPS mode out of the transverse electric-field mode.

Further, liquid crystal molecules in the liquid crystal layer LCL in the present embodiment have positive dielectric constants. That is, the liquid crystal used for the liquid crystal layer LCL is made of a liquid crystal material with positive type liquid-crystal properties.

Furthermore, a width W of the sub-pixel area PA in the present embodiment is, for example, 13 μm (definition of about 650 ppi) or less. The width W is preferably 12 μm (definition of about 700 ppi) or less, more preferably 0.5 μm (definition of about 800 ppi) or less, much more preferably 9.5 μm (definition of about 900 ppi) or less. In this case, a thickness T (see FIG. 2) of the liquid crystal layer LCL is, for example, 2.8 μm or less. In order to fulfill demands of the transmissivity and the high-speed response of liquid crystal simultaneously, a ratio of a relationship between the width W of the sub-pixel area PA and the thickness T of the liquid crystal layer LCL is, for example, that W/T is 3.5 or more, preferably 4 or more. Incidentally, the term “ppi” is an abbreviation of “pixel per inch”, which indicates definition of a pixel. Additionally, the pixel is a concept including the plural sub-pixels.

As shown in FIG. 6, the array substrate BS has the insulating layer IL4 that is present between the pixel electrode PE and the common electrode CE. The common electrode CE is present between the insulating layer IL4 and the liquid crystal layer LCL. That is, the sub-pixel structure of the array substrate BS is a structure in which the common electrode CE is located at a higher layer (on a liquid crystal layer LCL side) than the pixel electrode PE.

Incidentally, Patent Document 2 of a conventional technique discloses a conductive film for shielding a common electrode from an electric field, the conductive film and the common electrode being formed on different layers. In using a pixel with extremely higher definition, however, it is difficult to form two common-electrode wirings in a pixel area. Additionally, if the common-electrode wiring is formed, the common-electrode wiring made of metal brings significant deterioration in an aperture ratio. Further, in using the higher-definition pixel, an electric field generated around a gate line and an electric field generated between the pixels adjacent to each other via the gate line need to be properly shielded from each other. Therefore, as shown in FIG. 5, apt for the present invention is the common electrode CE having the opening OP that is placed on a plane surface. If such formation of the common electrode is adopted, an alignment film to be applied onto the common electrode CE becomes good in wettability and extendability.

In the present embodiment, the first electrode is the pixel electrode PE, and the second electrode is the common electrode CE formed over the plural sub-pixel areas PA, and is located so that the pixel electrode PE and the common electrode CE are not overlapped on the light transmission area TA in the sub-pixel area PA. That is, the pixel electrode PE and the common electrode CE each adopt a structure of realizing not the FFS mode but the IPS mode in the transverse electric-field mode.

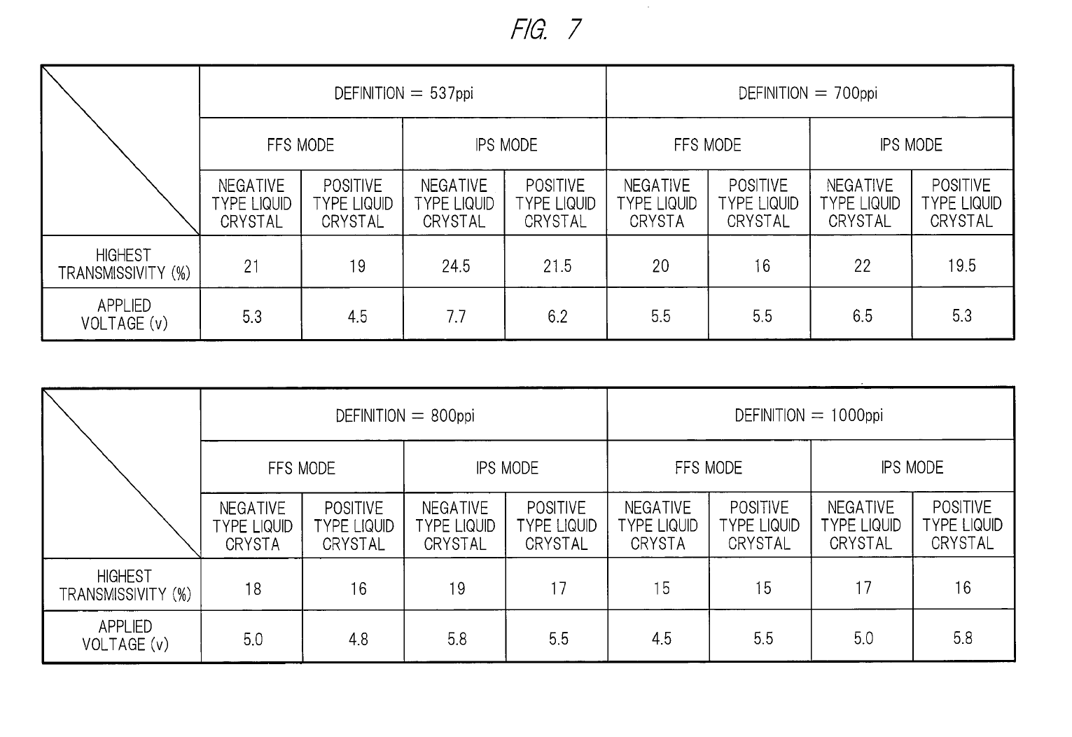

Here, a result(s) simulated by the inventors of this application about the sub-pixel structure will be explained with reference to FIG. 7. FIG. 7 is an explanatory diagram showing an example of a relationship between the highest transmissivity and an applied voltage with respect to definition of each mode about the present embodiment and a comparative example to the present embodiment.

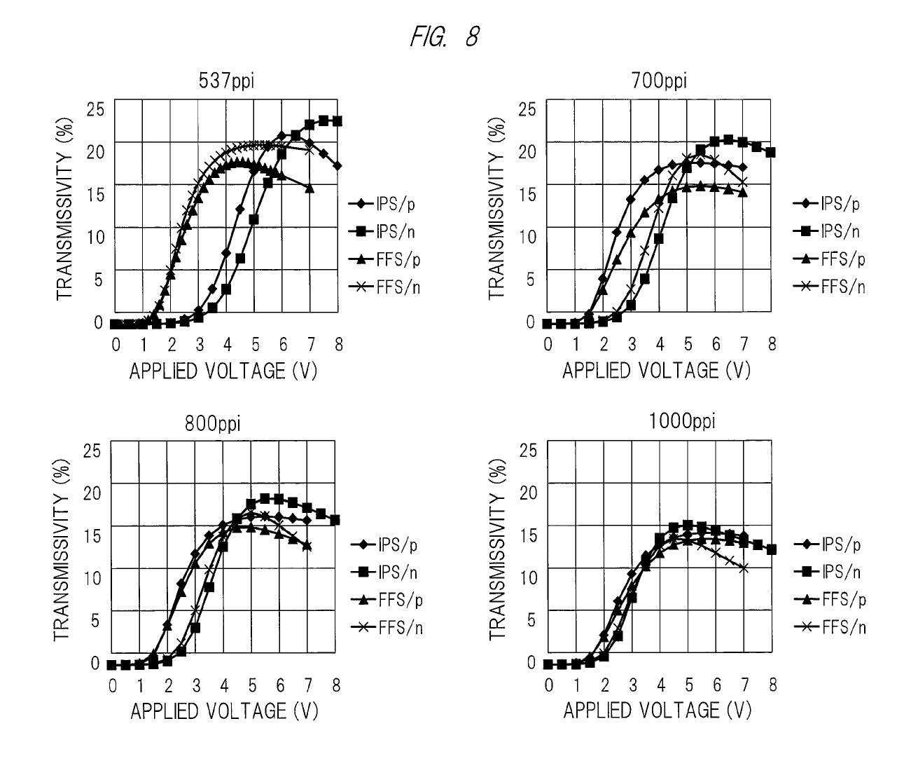

The present embodiment adopts, as mentioned above, the positive type liquid-crystal display device LCD with the IPS mode. In contract to this, an object of a comparative example to the present embodiment is a negative type liquid-crystal display device with the FFS mode, a positive type liquid-crystal display device with the FFS mode, or a negative type liquid-crystal display device with the IPS mode. Definitions of 537 ppi, 700 ppi, 800 ppi, and 1000 ppi are given as examples. Additionally, FIG. 8 shows a dependency between transmissivity and an applied voltage of each definition. Incidentally, the “positive type liquid crystal” in FIG. 8 is denoted as “p”, and the “negative type liquid crystal” therein is denoted as “n”.

As shown in FIG. 7, for example, under the condition that the definition is 537 ppi, the negative type liquid crystal in the FFS mode has the highest transmissivity of 21% and, at this time, an applied voltage of 5.3 V; the positive type liquid crystal in the FFS mode has the highest transmissivity of 19% and, at this time, an applied voltage of 4.5 V; the negative type liquid crystal in the IPS mode has the highest transmissivity of 24.5% and, at this time, an applied voltage of 7.7 V; and the positive type liquid crystal in the IPS mode has the highest transmissivity of 21.5% and, at this time, an applied voltage of 6.2 V. That is, the IPS mode needs to apply about 1.5 times higher voltage in order to obtain almost the same transmissivity as the FFS mode. Such a higher voltage is not desirable in terms of power consumption.

If used, the negative type liquid crystal in the IPS mode has a transmissivity of 13% at a time of applying a voltage of 5.3 V although those values are not shown in FIG. 7. Additionally, the positive type liquid crystal in the IPS mode has the same 13% transmissivity as the above at a time of applying a voltage of 4.5 V. Therefore, if the display device has a definition of about 537 ppi, the FFS mode is more advantageous in a relationship between transmissivity and power consumption than the IPS mode.

FIGS. 7 and 8 shows cases where the display device has a definition of 700 ppi higher than 537 ppi and a definition of 800 ppi higher than 700 ppi. When the IPS and FFS modes of the positive type liquid crystal are compared about each of definitions of 700 ppi and 800 ppi, it is understood that the positive type liquid crystal in the IPS mode is more advantageous in the highest transmissivity than that in the FFS mode, and both have almost the same applied voltage.

Further, under the condition that the definition is 1000 ppi higher than 800 ppi, the negative type liquid crystal in the FFS mode has the highest transmissivity of 15% and, at this time, an applied voltage of 4.5 V; the positive type liquid crystal in the FFS mode has the highest transmissivity of 15% and, at this time, an applied voltage of 5.5 V; the negative type liquid crystal in the IPS mode has the highest transmissivity of 17% and, at this time, an applied voltage of 5.0 V; and the positive type liquid crystal in the IPS mode has the highest transmissivity of 16% and, at this time, an applied voltage of 5.8 V. The IPS mode is more advantageous in the transmissivity and applied voltage about the above definition than the FFS mode.

As shown in FIGS. 7 and 8, as the definition becomes higher, the advantage of the FFS mode trends to disappearance and the IPS mode is consequently superior to the FFS mode. That is, in the display device adopting the definition whose sub-pixel area has a width of 13 μm (about 650 ppi) or more, the IPS mode is more advantageous than the FFS mode as a result of a comprehensive evaluation of the applied voltage and transmissivity.

More specifically, when the definition becomes very high, the highest transmissivity can be realized even if the applied voltage is low. This means to be capable of use as display with higher definition even by liquid crystal having a low dielectric constant. Such use leads to response speed being higher since the liquid crystal has low viscosity.

Further, as shown in FIGS. 7 and 8, as the definition becomes higher, the advantage of the higher transmissivity that the negative type liquid crystal has disappears. Under the condition that the definition is 700 ppi, the positive type liquid crystal making high-speed response is synthetically advantageous. Thus, in the display device LCD in which the higher definition and the higher-speed response are required, it is understood that the positive type liquid crystal in the IPS mode is advantageous in a high definition area with a transmissivity of 650 ppi or more.

The display device LCD according to the present embodiment explained above can realize the higher definition and the high-speed response. Therefore, since a distance from viewer's eyes to a display screen is short and adaptation to a moving image(s) is made, such realization can be desirably applied to the display device LCD such as the head mounted display (HMD) in which the higher definition and the high-speed response are required.

<Modifications of Sub-Pixel Structure>

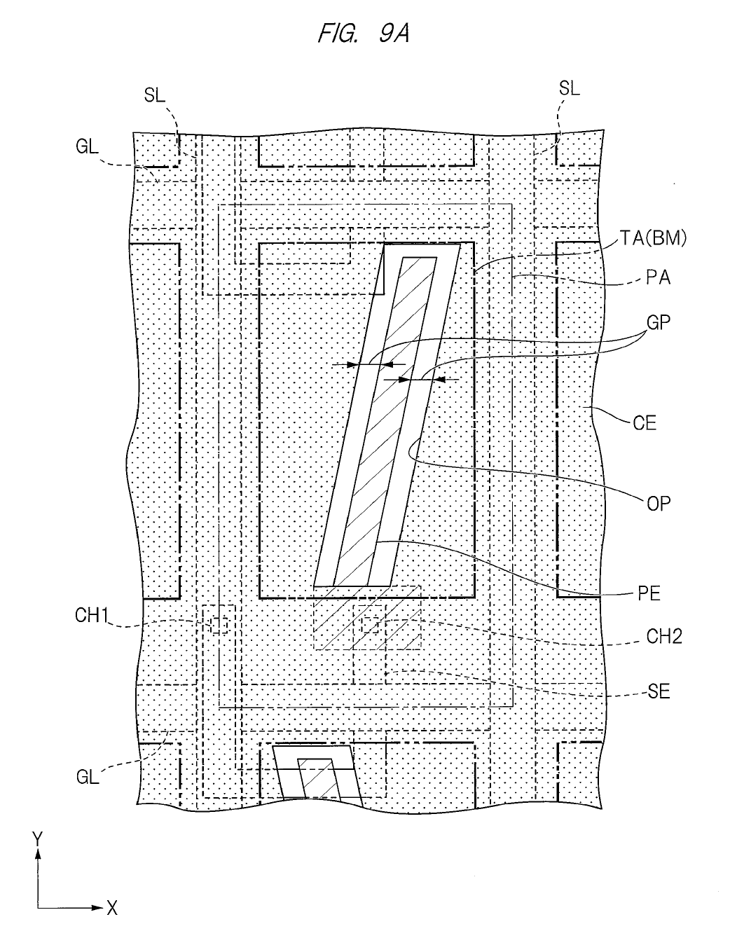

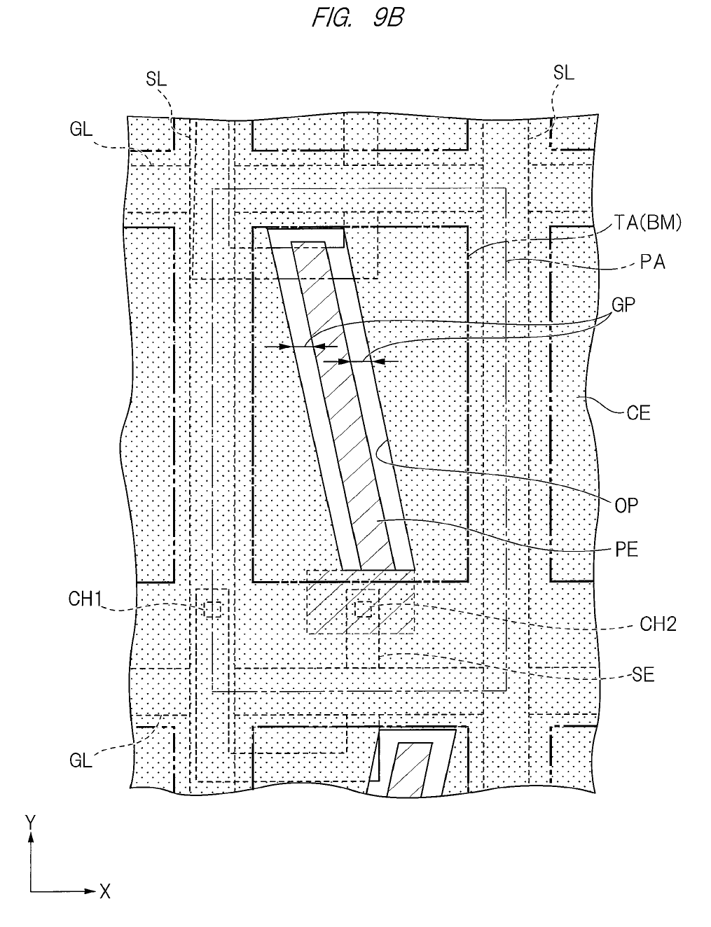

Next, modifications of the sub-pixel structure will be explained with reference to FIGS. 9A and 9B. FIGS. 9A and 9B are plan views each showing a modification of the sub-pixel structure of the display device according to the embodiment. Here, a difference between the sub-pixel structure shown in FIG. 5 and each of the modifications will be explained mainly.

In each of sub-pixel structures shown in FIGS. 9a and 9B, the pixel electrode PE adopts such a structure as to extend in a direction slanting to the Y-axis direction in which the image lines SL extend. In addition thereto, the opening OP overlapped on the pixel electrode PE also adopts such a shape as to extend in a direction slanting to the Y-axis direction that the image lines SL extend.

In other words, the image lines SL extend so as not to be arranged along ends of the opening OP. In order to uniformly apply an electric field to an interior of the sub-pixel area, the image lines SL desirably extend so as to be arranged along the ends of the opening OP. In a case of the modification, however, each of the image lines SL results in having a bending portion per sub-pixel area. A width of the light shielding film BM with respect to this bending portion needs to be formed thickly, and if the number of bending portions is large, an aperture ratio results in degradation. Therefore, in the high-definition display device like the present invention, it is preferable not to bend each image line SL.

FIG. 9A shows such an example that the pixel electrode PE and the opening OP slant to a right direction with respect to the Y-axis direction. In this case, each of the sub-pixels arranged in the X-axis direction with respect to the pixel shown in FIG. 9A also becomes a sub-pixel structure in which the pixel electrode PE and the opening OP slant to the right direction with respect to the Y-axis direction similarly to the above. Meanwhile, each of the sub-pixels, which are adjacent to the pixel shown in FIG. 9A in the Y-axis direction and are arranged in the X-axis direction, becomes a sub-pixel structure in which the pixel electrode PE and the opening OP slant to a left direction with respect to the Y-axis direction to the contrary (FIG. 9B). That is, each of the pixels arranged in a matrix in the X-axis and Y-axis directions results in having, for example, the following sub-pixel structure (FIG. 9B): if attention is paid to the X-axis direction, the pixels connected to the odd-numbered scanning lines GL slant to the right direction with respect to the Y-axis direction, and the pixels connected to the even-numbered scanning lines GL slant to the left direction with respect to the Y-axis direction.

The sub-pixel structures shown in FIGS. 9A and 9B can realize measures against domain. That is, in the IPS mode, if regions different in a rotational direction of each liquid crystal molecule are present in the sub-pixel, so-called domain occurs at a boundary between the region in which each liquid crystal molecule rotates in a forward direction and the region in which each liquid crystal molecule rotates in a backward direction. This domain generally causes a streak-shaped part to occur, the part having low or high transmissivity, and thereby adversely affects brightness and contrast of a display screen. Since the display device adopts the sub-pixel structures in each of which the pixel electrode PE slants in the Y-axis direction and that are shown in FIGS. 9A and 9B, it is possible to prevent each liquid crystal molecule from rotating in an inverse direction, and to suppress occurrence of the domain.

Additionally, in a case where the pixel electrode PE slants in the Y-axis direction in comparison to a case where the pixel electrode PE extends parallel to the Y-axis direction, a color of light to be transmitted takes on slightly yellow or blue. By causing the structures shown in FIGS. 9A and 9B to be arranged adjacently in the Y-axis direction, however, it is possible to cancel occurrence of a phenomenon in which the color of light changes to yellow or blue.

### Another Embodiment

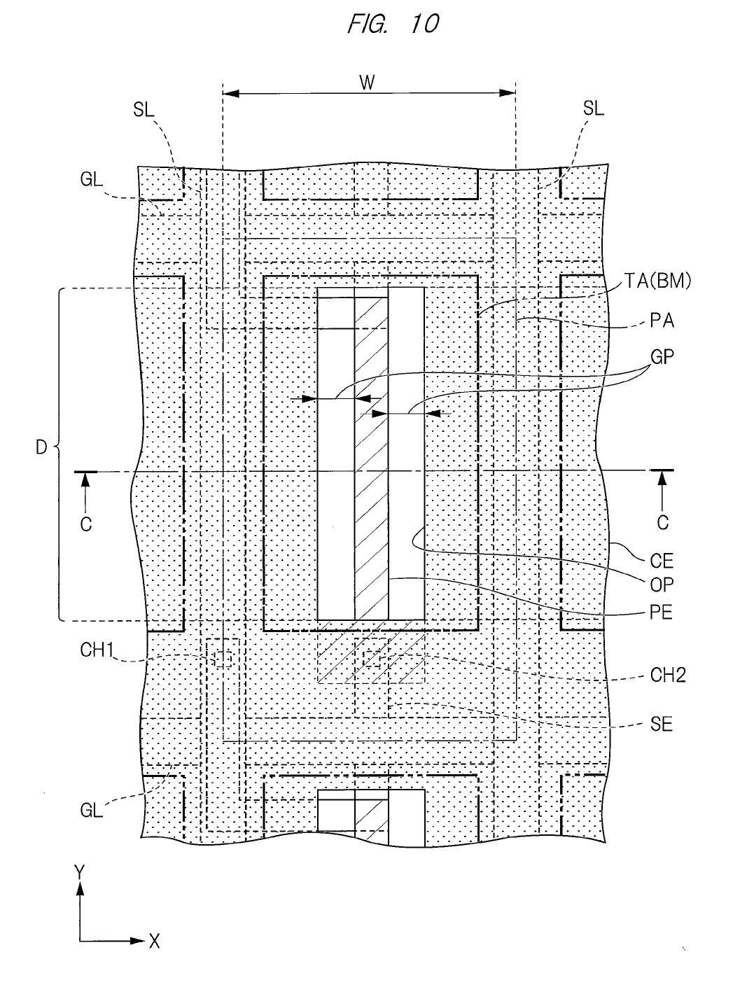

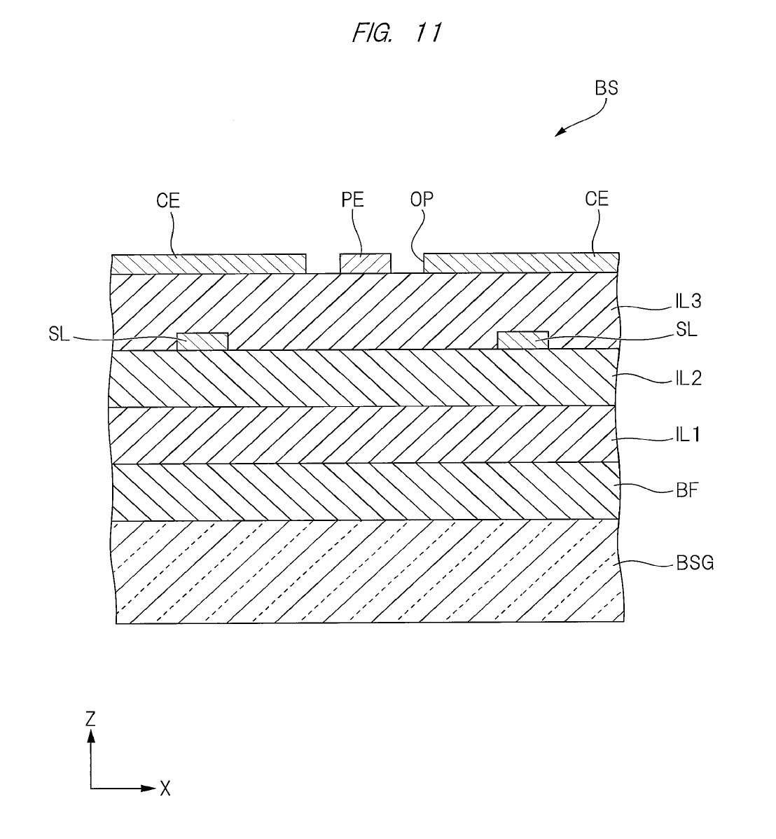

Next, another embodiment will be explained with reference to FIGS. 10 and 11. FIG. 10 is a plan view showing an example of a sub-pixel structure of a display device according to another embodiment. FIG. 11 is a sectional view taken along line C-C of FIG. 10. In a description of another embodiment, a difference between the above-mentioned embodiment and another embodiment will be explained mainly.

A sub-pixel structure shown in FIGS. 10 and 11 has a structure in which the insulating layer IL4 in an area corresponding to the opening OP of the common electrode CE is removed from the entirety of the insulating layer IL4. In this case, the insulating layer IL4 in the area corresponding to the opening OP of the common electrode CE is removed including an area of the image line SL like a region D indicated by broken lines in FIG. 10. That is, the insulating layer IL4 is continuously removed over the plural pixels Pix (sub-pixels SPix). The insulating layer IL4 is formed by an inorganic film made of, for example, SiN etc.

In a method of making such a sub-pixel structure, for example, the image electrode PE is formed, and then an area corresponding to the opening OP is masked to form the insulating layer IL4 made of an inorganic film. At this time, the insulating layer IL4 is formed in an area from which the opening OP is excluded, but is not formed in an area of the opening OP. Thereafter, the common electrode CE is formed thereon, so that the common electrode CE and the pixel electrode PE are present on different layers in the area from which the opening OP is excluded and so that the common electrode CE and the pixel electrode PE are present on the same layer.

In addition to obtaining almost the same effect as that of the above-mentioned embodiment, the area corresponding to the opening OP is removed in the sub-pixel structure shown in FIGS. 10 and 11, so that the common electrode CE and the pixel electrode PE are present on the same layer, which makes it possible to increase its transmissivity. Further, the insulating layer IL4 is removed from the area corresponding to the opening OP, which brings no capacitor layer and a decrease in a threshold voltage of a liquid crystal display element(s). The decrease in the threshold voltage makes it possible to apply liquid crystal with lower transmissivity, namely, liquid crystal with lower viscosity, and the response speed can be further improved consequently.

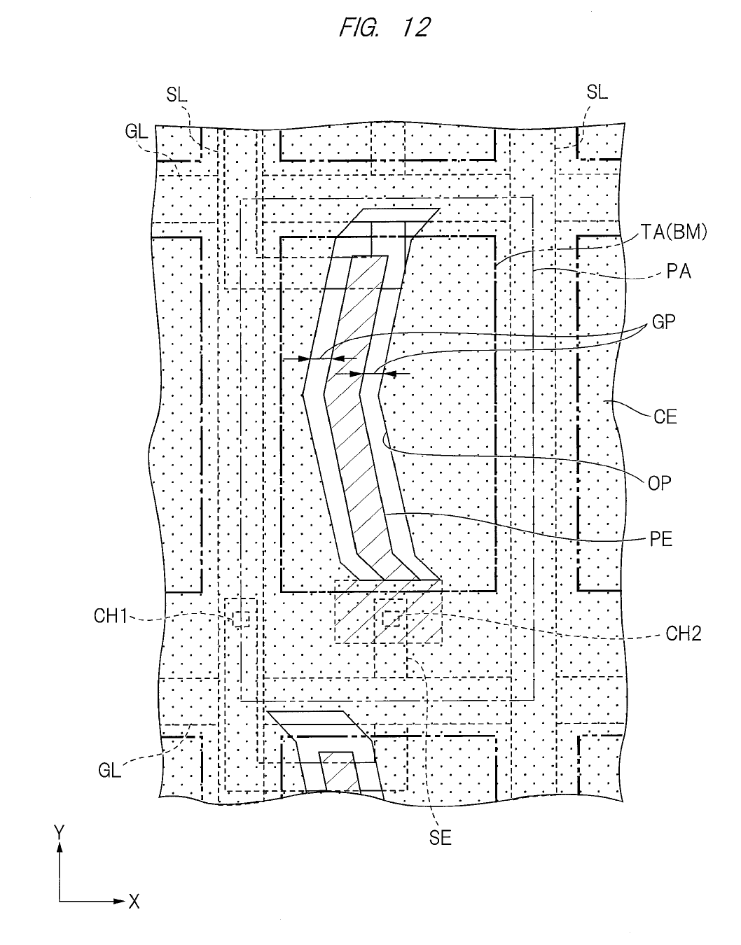

Incidentally, a domain-countermeasure structure as shown in FIG. 12 may be adopted as domain-countermeasure structures shown in FIGS. 9A and 9B. FIGS. 9A and 9B show the domain-countermeasure structures in which two sub-pixel structures adjacent to each other in the Y-axis direction are used, while FIG. 12 shows a domain-countermeasure structure in which one sub-pixel structure is used. To slant the pixel electrode PE is important to the measures against the domain. However, as the definition becomes higher, the width of the sub-pixel area is smaller, and the image line SL becomes a structure to be not bent. In this case, in the cases of the pixel electrodes as shown in FIGS. 9A and 9B, there is a possibility that an electric field generated near the end of the pixel electrode will drive liquid crystal in the pixel electrode adjacent thereto. However, if the pixel electrode PE has the bending portions as shown in FIG. 12, it is possible to reduce an influence on the pixel(s) adjacent to the pixel electrode by the pixel electrode PE.

Incidentally, as shown in FIG. 12, the opening OP, the pixel electrode PE, and the semiconductor layer SE are overlapped in order to locate the opening OP at a center of the sub-pixel area. Since the vicinity of the semiconductor layer SE is an area through which light from the backlight is difficult to transmit, an area on or over the semiconductor layer SE is to be an area for forming the pixel electrode PE. The area of the pixel electrode PE is an area having a weak electric field, so that the transmissivity of the entirety of the sub-pixel area is improved by superimposing this area on the semiconductor layer SE.

In the foregoing, the invention made by the inventors of the present invention has been concretely described based on the embodiments. However, it is needless to say that the present invention is not limited to the foregoing embodiments and various modifications and alterations can be made within the scope of the present invention.

A person having an ordinary skill in the art can make various modification examples and correction examples within a scope of the idea of the present invention, and it is interpreted that the modification examples and the correction examples also belong to the scope of the present invention.

For example, the examples obtained by performing addition or elimination of components or design change or the examples obtained by performing addition or reduction of process or condition change to the embodiment described above by a person having an ordinary skill in the art are also included in the scope of the present invention as long as they include the gist of the present invention.

What is claimed is:

1. A display device comprising:
an insulating base material;
a plurality of image lines and a plurality of scanning lines over the insulating base material;
a light shielding film overlapped on the image lines and the scanning lines;
a first electrode and a second electrode present in at least one sub-pixel area surrounded by the image lines and the scanning lines in a plan view; and
a liquid crystal layer driven by an electric field generated between the first and second electrodes,
wherein a shape of the first electrode in a light transmission area overlapped by the light shielding film is a linear shape having no bending portion,
the second electrode is overlapped on the image lines and the scanning lines, and has an opening overlapped on the first electrode,
each liquid crystal molecule in the liquid crystal layer has a positive dielectric constant, and
the sub-pixel area has a width of 13 μm or less.

2. The display device according to claim 1, further comprising an insulating layer between the first and second electrodes,
wherein the second electrode is present between the insulating layer and the liquid crystal layer.

3. The display device according to claim 1,
wherein the first electrode is a pixel electrode, and the second electrode is a common electrode formed over the plural sub-pixel areas.

4. The display device according to claim 1,
wherein the first and second electrodes in the light transmission area is not overlapped.

5. The display device according to claim 1,
wherein the liquid crystal layer has a thickness of 2.8 μm or less.

6. The display device according to claim 5,
wherein a width W of the sub-pixel area and a thickness T of the liquid crystal layer have such a relation that a ratio W/T is 3.5 or more.

7. The display device according to claim 4,
wherein the opening is overlapped on the image lines or scanning lines.

8. The display device according to claim 1,
wherein the image lines extend in a first direction, and the first electrode extends in a direction slanting to the first direction.

9. The display device according to claim 8,
wherein the first electrode has a bending portion.

10. The display device according to claim 1,
wherein the display device is used in a head mounted display.

11. The display device according to claim 2,
wherein the first electrode is a pixel electrode, and the second electrode is a common electrode formed over the plural sub-pixel areas.

12. The display device according to claim 2,
wherein the first and second electrodes in the light transmission area is not overlapped.

13. The display device according to claim 11,
wherein the first and second electrodes in the light transmission area is not overlapped.

14. The display device according to claim 2,
wherein the liquid crystal layer has a thickness of 2.8 μm or less.

15. The display device according to claim 3,
wherein the liquid crystal layer has a thickness of 2.8 μm or less.

16. The display device according to claim 4,
wherein the liquid crystal layer has a thickness of 2.8 μm or less.

17. The display device according to claim 11,
wherein the liquid crystal layer has a width of 2.8 μm or less.

18. The display device according to claim 12,
wherein a width W of the sub-pixel area and a thickness T of the liquid crystal layer have such a relation that a ratio W/T is 3.5 or more.

19. The display device according to claim 15,
wherein a width W of the sub-pixel area and a thickness T of the liquid crystal layer have such a relation that a ratio W/T is 3.5 or more.

20. The display device according to claim 16,
wherein a width W of the sub-pixel area and a thickness T of the liquid crystal layer have such a relation that a ratio W/T is 3.5 or more.
